(19) United States
(12) Patent Application Publication
(10) Pub. No.: US 2016/0201387 A1
(43) Pub. Date: Jul. 14, 2016

(54) BARRIER ASSEMBLY

(71) Applicant: Randall Allen, Fayetteville, NC (US)

(72) Inventor: Randall Allen, Fayetteville, NC (US)

(21) Appl. No.: 14/592,904

(22) Filed: Jan. 9, 2015

(51) Int. Cl. E06B 9/06; E06B 9/01; E06B 9/52

(52) U.S. Cl. CPC E06B 9/0692; E06B 9/521; E06B 9/01; E06B 2009/015; E06B 2009/002

(57) ABSTRACT

A barrier assembly includes a building that has an opening to provide access into the building. A door is coupled to the building and is positionable in an open position and a closed position. A net is removably extendable across the opening to prevent an individual from exiting the building when the door is positioned in the open position. The net has a first end section, a central section and a second end section. A retainer is coupled to the net and engages the building to retain the net across the opening. Each of the first end section and the second end section is positioned to extend beyond a threshold of the opening and abut the inside surface. Each of the first end section and the second end section prevent the individual from slipping between the inside surface and the central section.

### BACKGROUND OF THE DISCLOSURE

### Field of the Disclosure

The disclosure relates to barrier devices and more particularly pertains to a new barrier device for preventing an individual from exiting a building while a door to the building is open.

### SUMMARY OF THE DISCLOSURE

An embodiment of the disclosure meets the needs presented above by generally comprising a building that has an opening to provide access into the building. A door is coupled to the building and is positionable in an open position and a closed position. A net is removably extendable across the opening to prevent an individual from exiting the building when the door is positioned in the open position. The net has a first end section, a central section and a second end section. A retainer is coupled to the net and engages the building to retain the net across the opening. Each of the first end section and the second end section is positioned to extend beyond a threshold of the opening and abut the inside surface. Each of the first end section and the second end section prevent the individual from slipping between the inside surface and the central section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a barrier assembly according to an embodiment of the disclosure.

FIG. 2 is a front view of an embodiment of the disclosure.

FIG. 3 is a back perspective view of an embodiment of the disclosure.

FIG. 4 is a perspective in-use view of an embodiment of the disclosure.

### DESCRIPTION OF THE PREFERRED EMBODIMENT

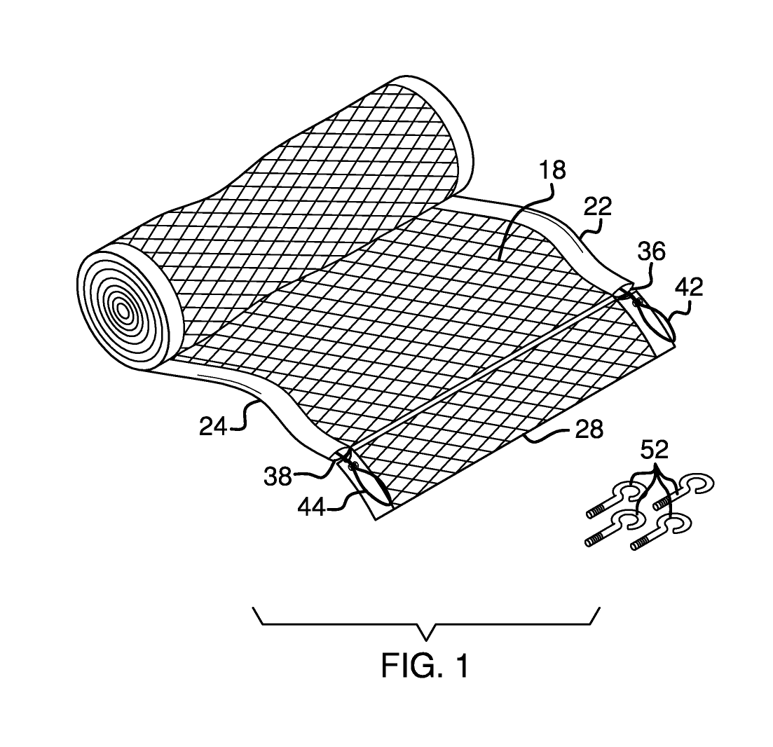

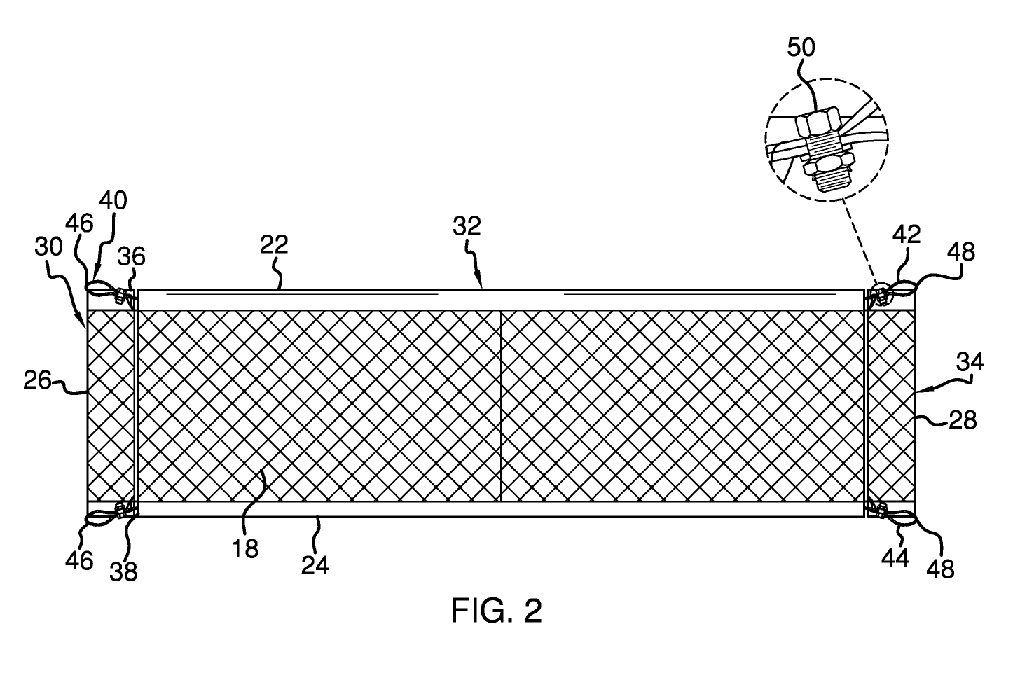

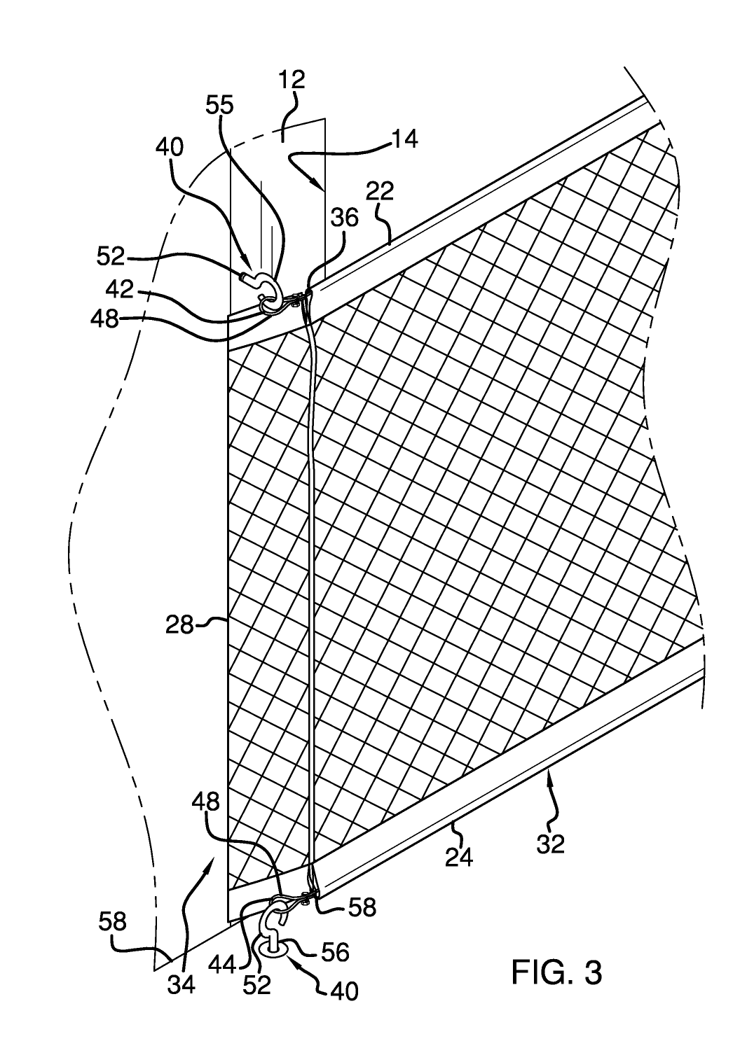

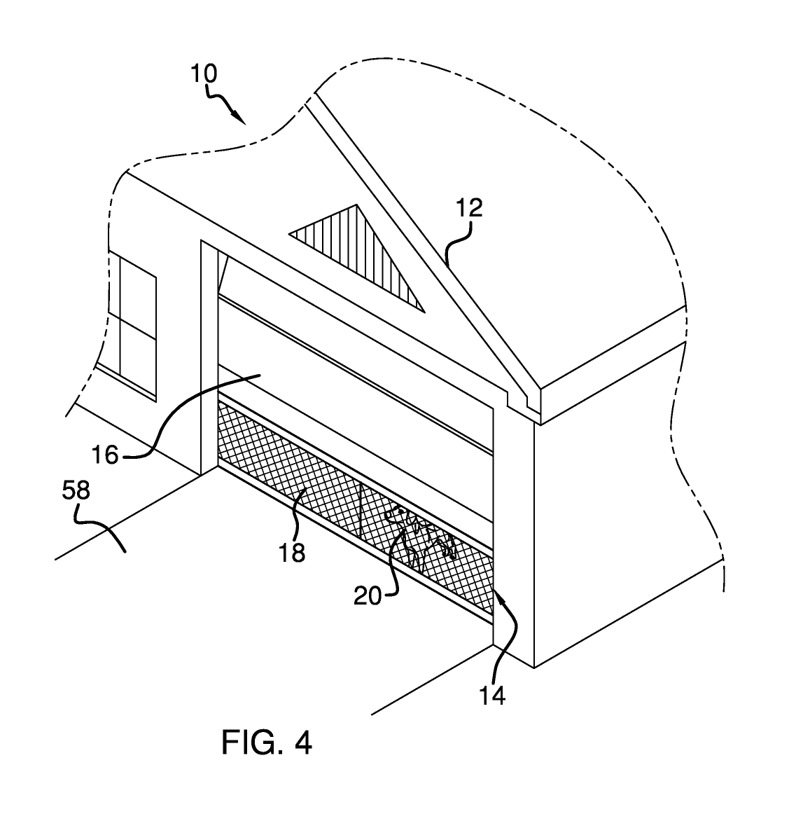

With reference now to the drawings, and in particular to FIGS. 1 through 4 thereof, a new barrier device embodying the principles and concepts of an embodiment of the disclosure and generally designated by the reference numeral 10 will be described.

As best illustrated in FIGS. 1 through 4, the barrier assembly 10 generally comprises a building 12 that has an opening 14 to provide access into the building 12. The building 12 may be a garage or the like. The opening 14 may be a garage door opening. A door 16 is coupled to the building 12 and is positionable in an open position and a closed position. The door 16 may be a garage door of any conventional design.

A net 18 is removably extendable across the opening 14 to prevent an individual 20 from exiting the building 12 when the door 16 is positioned in the open position. The individual 20 may be a pet or a child. The net 18 has a top edge 22, a bottom edge 24, a first end 26 and a second end 28. The net 18 is elongated between the first end 26 and the second end 28. The net 18 has a first end section 30, a central section 32 and a second end section 34. Each of the first end section 30 and the second end section 34 are positioned adjacent to an associated one of the first end 26 and the second end 28. The top edge 22 and the bottom edge 24 defines a top channel 36 and a bottom channel 38 that are each coextensive with the central section 32.

A retainer 40 is coupled to the net 18 to engage the building 12 and retain the net 18 across the opening. The retainer 40 comprises a first cable 42 and a second cable 44 that each has a first end 46 and a second end 48. The first cable 42 is positioned in the top channel 36 and the second cable 44 is positioned in the bottom channel 38. Each of the first ends 46 and the second ends 48 extend outwardly from the top channel 36 and the bottom channel 38. The first ends 46 are positioned between the central section 32 and the first end section 30 and the second ends 48 are positioned between the central section 32 and the second end section 34.

The first ends 46 and the second ends 48 each comprise a closed loop. The first 46 and second 48 ends may be folded back onto the respective cables 42, 44. A plurality of couplers 50 may each retain the first 46 and second 48 ends on the respective cables 42, 44 to define the closed loop. The cables 42, 44 may each be manufactured to have the closed loop at each of the first ends 46 and the second ends 48.

A plurality of fasteners 52 is provided to engage an inside surface 54 of the building 12. Each of the fasteners 52 is positioned adjacent to the opening 14. The fasteners 52 include a top pair of fasteners 55 and a bottom pair of fasteners 56. The top pair of fasteners 55 is spaced upwardly from ground 58. The bottom pair of fasteners 56 is positioned adjacent to ground 58. Each of the fasteners 52 may be hook bolts or the like. Alternatively, each of the bottom pair of fasteners 56 may engage ground 58 such that the bottom pair of fasteners 56 is each positioned adjacent to the opening 14.

Each of the first ends 46 and the second ends 48 engage one of the fasteners 52 so the net 18 is stretched across the opening 14. Each of the first end section 30 and the second end section 34 are positioned to extend beyond a threshold of the opening 14 and abut the inside surface 54. Each of the first end section 30 and the second end section 34 prevent the individual 20 from slipping between the inside surface 54 and the central section 32.

In use, the net 18 is stretched across the opening 14 to prevent the individual 20 from exiting the building 12 when the door 16 is in the open position. The first cable 46 is disconnected from each of the top pair of fasteners 55 and the net 18 is dropped to ground 58 when a vehicle or other object is to be removed from the building 12. Alternatively, the first ends 46 of each of the first cable 42 and the second cable 44 are removed from the respective fasteners 52 and the net 18 is rolled to the other side of the opening 14 when the vehicle or object is to be removed from the building 12. The net 18 allows the door 16 to be positioned on the open position to ventilate the building 12 while preventing the individual 20 from exiting the building 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. (canceled)

5. A barrier assembly configured to extend across a garage door opening thereby simultaneously preventing a pet from exiting the garage and providing ventilation for the garage, said assembly comprising:
a building having an opening to provide access into said building;
a door coupled to said building, said door being positionable in an open position and a closed position;
a net being removably extendable across said opening, said net being configured to prevent an individual from exiting said building when said door is positioned in said open position, said net having a top edge, a bottom edge, a first end and a second end, said net being elongated between said first end and said second end, said net having a first end section, a central section and a second end section, each of said first end section and said second end section being positioned adjacent to an associated one of said first end and said second end, said top edge and said bottom edge defining a top channel and a bottom channel, each of said top channel and said bottom channel being coextensive with said central section;
a retainer coupled to said net, said retainer engaging said building to retain said net across said opening, said retainer comprising:
a first cable and a second cable each having a first end and a second end, said first cable being positioned in said top channel, said second cable being positioned in said bottom channel, each of said first ends and said second ends extending outwardly from said top channel and said bottom channel, said first ends being positioned between said central section and said first end section, said second ends being positioned between said central section and said second end section, said first ends and said second ends each comprising a closed loop secured by a retainer;
a plurality of fasteners, each of said fasteners engaging an inside surface of said building, each of said fasteners being positioned adjacent to said opening, each of said fasteners having a gap therein wherein each said fastener receives an associated one of said closed loops without disengaging said retainer, each of said first ends and said second ends engaging one of said fasteners such that said net is stretched across said opening, each of said first end section and said second end section being positioned to extend beyond a threshold of said opening and abut said inside surface, each of said first end section and said second end section being configured to prevent the individual from slipping between said inside surface and said central section.
